(19) United States
(12) Patent Application Publication
(10) Pub. No.: US 2020/0117706 A1
(43) Pub. Date: Apr. 16, 2020

(54) METHOD AND SYSTEM FOR REWRITING GENDERED WORDS IN TEXT

(71) Applicants: Emily S. Parkhurst, (US); John Mark Fullmer, (US)

(72) Inventors: Emily S. Parkhurst, Los Angeles, CA (US); John Mark Fullmer, Tucson, AZ (US)

(21) Appl. No.: 16/160,615

(22) Filed: Oct. 15, 2018

(51) Int. Cl. G06F 17/24; G06F 17/27

(52) U.S. Cl. CPC G06F 17/24; G06F 17/274

(57) ABSTRACT

The method and system for rewriting gendered words in text replaces one or more original gendered words connoting a first gender in a text with one or more gendered words connoting a second gender to generate a gender modified text. A computer system is provided with a predetermined array of gendered key word variables, and provides a user with a preliminary placeholder modified text to allow a user to tag each of the gendered words with an appropriate persona name, to identify any gendered words that are special determiners for use by the computer system, and to add a legend identifying which gender should be used for the gendered words. The computer system then transforms the text according to the array of gendered key word variables, and outputs the gender modified text.

### BACKGROUND

The present invention relates generally to word replacement in text, and more particularly relates to a method and system for rewriting gendered words in text to generate a gender modified text.

Unconscious biases relating to gender of characters continue in narrative fiction, both in print and on screen. While the top two domestic grossing movies of 2017 starred women, typically most roles in film, leading and otherwise, go to men. According to a review of the 700 top-grossing films from 2007 to 2014 conducted by the University of Southern California, women have less than a third of speaking roles in film. According to a 2017 study by the Gina Davis Institute, men also get more speaking time in ads. In addition, in most Disney princess films, the amount of time women get to talk or act is typically overshadowed by the male characters in those films. Research has shown similar gender imbalances in a broad spectrum of literature, from children's stories to award-winning literary fiction and best selling genres like sci-fi and fantasy. For example, a comprehensive study in 2011 of 20th century children's books found a bias towards tales that feature men and boys as lead characters, and found that even when characters are animals they are typically male.

Changing the gender of characters in stories can change the stories in ways that challenge our unconscious biases about gender. Changing a character's gender reflects not only on that character, but can change multiple aspects of the whole story. For example, if the gender of a male hero, such as Conan the Barbarian, were to be changed to a female hero, such as Cuzha the Barbarian, the character in the story would remain an unparalleled warrior, adventuring in exotic lands and soundly defeating all foes, challenging a common tendency to imagine only men in such roles. Changing the gender of a hero also can change the character from a hero to a villain, or vice versa. For example, if the character of the Queen of Hearts from Alice in Wonderland were to be changed from a paranoid, hysterical shrew screaming “Off with their heads”, to a man, the character may be perceived as a ruthless tyrant, a bloodthirsty dictator, someone to be taken seriously. Changing gender of a character in a story may also affect our perceptions of sexual orientation of the character. For example, in a story in which the hero Conan the Barbarian seduces the Queen of the Black Coast, changing the gender of either of these characters could produce a story in which either the male hero Conan the Barbarian takes a King as a lover, or a female hero Cuzha the Barbarian seduces the Queen of the Black Coast. Accordingly, it would be desirable to provide a system and method for rewriting the gender of personae in text, particularly in fiction, as a way of challenging a reader's unconscious biases about gender.

One method for performing replacement of textual strings in text utilizing linguistic processing is known in which the existence of direct or indirect links between a string to be replaced and other strings in the text is identified, and inconsistencies that would otherwise be introduced by the replacement of textual strings are detected and corrected.

Another system is known that can assist a user with gender usage during composition of electronic documents, emails, or letters. Centralized databases using proper names mentioned in the composition are checked, and gender-related information is retrieved to assist the user with gender recognition tools while composing gender-sensitive statements.

A system for placing linguistically-aware variables in computer-generated text is also known, in which the system receives a sentence, utilizes a variable that is a placeholder for a first word, and automatically determines a gender of the first word. The system analyzes the sentence to identify a dependent word having a spelling that is dependent on the gender of the first word. The system determines the spelling of the dependent word, and replaces the first variable in the sentence with the first word.

Another system is known for generating markup language text templates that identifies a variable text element in a source language text string, and assigns a first predefined symbol to the variable text element. A grammatical rule for the variable text element is identified, and a second predefined symbol is assigned to the variable text element based on the identified grammatical rule, and whether to assign supplemental information to the variable text element is determined. The first predefined symbol, second predefined symbol, and supplemental information represent a token. The identification of a grammatical rule, assignment of first and second predefined symbols, and determination of whether to assign supplemental information for remaining variable text elements in the source language text string is repeated to complete a markup language text template including one or more tokens.

It would be desirable to provide a method and system for rewriting gendered words in text to change the text in ways that can challenge unconscious biases about gender, and that can change multiple aspects of a story. The present invention meets these and other needs.

### SUMMARY OF THE INVENTION

Briefly, and in general terms, the invention provides for a method and system for rewriting an original text by replacing one or more original gendered words referring to a first gender with one or more corresponding substitute gendered words referring to a second gender to produce a gender modified text.

The present invention accordingly provides for a method for rewriting at least a portion of an original text that includes one or more personae having a corresponding first gender and one or more original gendered words corresponding to the first gender of the one or more personae. A computer system is provided with a predetermined array of gendered key word variables corresponding to a plurality of gendered words, typically including parts of speech, phrases and proper names, for a predetermined plurality of alternate genders, respectively. The computer system finds and replaces the one or more gendered words of the original text with a preliminary placeholder, which includes the gendered word and a temporary name placeholder for a corresponding persona or character to which the gendered word refers, to generate a preliminary placeholder modified text.

The preliminary placeholder modified text is provided to a user who adds a legend to the preliminary placeholder modified text. The legend includes, for each of the one or more personae, a plurality of different persona names, and a selected gender from among the predetermined plurality of alternate genders for the one or more personae, with each of the plurality of different persona names corresponding to one of the predetermined plurality of alternate genders, respectively.

The user finds and replaces each temporary name placeholder in each corresponding preliminary placeholder in the preliminary placeholder modified text with a corresponding persona name placeholder that includes one of the persona names from the legend to which the corresponding gendered word refers, and finds and replaces each freestanding persona name in the preliminary placeholder modified text with a corresponding persona name placeholder including the freestanding persona name.

The user also finds any gendered word in the preliminary placeholder modified text having a display word form that is different from a corresponding determiner key word variable in the predetermined array of gendered key word variables, and replaces each such display word form of the gendered word with the corresponding determiner gendered key word variable, respectively, to generate an intermediate gender placeholder modified text.

The legend in the intermediate gender placeholder modified text is then modified to change at least one selected gender for the one or more personae to a second gender different from the first gender in the original text to provide a gender placeholder modified text.

The computer system is provided with the gender placeholder modified text, and the computer system transforms the gender placeholder modified text according to the array of gendered key word variables by replacing each gender placeholder in the gender placeholder modified text with a corresponding one of the gendered key word variables, respectively, to generate a gender modified text.

In a presently preferred aspect, the predetermined plurality of alternate genders includes three alternate genders, and the array of gendered key word variables includes a plurality of types of gendered words, each including three different gender key word variables indicating the three alternate genders, respectively.

In another presently preferred aspect, the legend includes first and second elements for each of the one or more personae, wherein the first element indicates three alternate proper names corresponding to three alternate genders, respectively, and the second element indicates a preselected one of the three alternate genders.

In another presently preferred aspect, the array of gendered key word variables includes a display word form for a corresponding gendered key word variable that is different from the corresponding gendered key word variable, and the display word form in the personae gender indicator placeholder modified text is substituted for the corresponding gendered key word variable to provide the substitute gendered word corresponding to the second gender. In another presently preferred aspect, the display word form is a possessive adjective.

In another presently preferred aspect, the legend includes three different names for three corresponding alternate genders and a selected one of three alternate genders for a plurality of different personae, respectively. In another presently preferred aspect, the legend may also include a title, a genre, a date of original publication, a word count and an author of the text. In another presently preferred aspect, the step of modifying the legend includes a user selecting one of the predetermined plurality of alternate genders for the corresponding one or more personae. In another presently preferred aspect, the step of modifying the legend includes the computer system randomly selecting one of the predetermined plurality of alternate genders for the corresponding one or more personae.

The present invention also provides for a system for rewriting at least a portion of an original text that includes one or more personae having a corresponding first gender and one or more original gendered words corresponding to the first gender of the one or more personae. The system includes a computer system that is provided with a predetermined array of gendered key word variables corresponding to a plurality of gendered words, typically including parts of speech, phrases and proper names, for a predetermined plurality of alternate genders, respectively. The computer system is operative to find and replace the corresponding one or more gendered words of the original text with a preliminary placeholder, which includes the gendered word and a temporary name placeholder for a corresponding persona or character to which the gendered word refers, to generate a preliminary placeholder modified text.

The computer system includes means operative to permit a user to add a legend to the preliminary placeholder modified text, the legend including, for each persona, a plurality of different persona names, and a selected gender from among the predetermined plurality of alternate genders for the persona, each of the plurality of different persona names corresponding to one of the predetermined plurality of alternate genders, respectively.

The computer system also includes means operative to permit a user to find and replace each temporary name placeholder in each corresponding preliminary gender indicator placeholder in the preliminary placeholder modified text with a corresponding persona name placeholder including one of the persona names from the legend to which the corresponding gendered word refers, and to find and replace each freestanding persona name in the preliminary placeholder modified text with a corresponding persona name placeholder including the freestanding persona name.

The computer system also includes means operative to permit a user to permit a user to find any gendered word in said preliminary placeholder modified text having a display word form and a corresponding different determiner key word variable in the predetermined array of gendered key word variables, and to replace each such display word form of the gendered word with the corresponding determiner gendered key word variable, respectively, to generate an intermediate gender placeholder modified text.

The computer system also includes means operative to permit a user to modify the legend in the intermediate gender placeholder modified text to change a selected gender for the one or more personae to a second gender different from the first gender of the one or more personae in the original text, to provide a gender placeholder modified text.

The computer system is operative to transform the gender placeholder modified text according to the array of gendered key word variables by replacing each gender placeholder in the gender placeholder modified text with a corresponding one of the gendered key word variables, respectively, to generate a gender modified text; and the system includes means for outputting the gender modified text.

Changing a character's gender can change a story in multiple ways, and can demonstrate unconscious biases of the author and of readers. In real life, women have taken on roles traditionally held by men, such as in the military, corporations, or government, for example, leading to changes in the way that they are addressed and discussed, and as more transgender individuals take on such roles in society, there is a growing need for appropriate language for addressing and discussing them as well. The method and system of the present invention can be useful as an educational resource for learning how changing gender can affect the language used to discuss roles and relationships of men, women and non-binary people in society, and can be used for exploring biases about gender in society and in literature, such as by readers and writers, students and teachers.

These and other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a flow chart illustrating the method and system according to the present invention.

FIG. 2 is an example of a legend.

FIG. 3 is an example of a legend for multiple personae.

FIG. 4 is an example of a preliminary placeholder.

FIG. 5 is an exemplary predetermined array or word map of gendered key word variables.

FIG. 6 is an exemplary persona name placeholder.

FIG. 7 is an example of a properly parameterized gender placeholder.

### DETAILED DESCRIPTION OF THE PREFERRED EMBODIMENTS

The method and system of the present invention permit a user to dynamically rewrite the gender of personae in texts. The present invention allows a user to dynamically interact with the gender of personae in texts, in the sense that the present invention utilizes a computer system accessible to a user, typically such as by a computer connected to a website accessible through the Internet, or other suitable computer systems, such as a typical stand alone computer, or other similar computer systems, for example, which allows a user to radically alter the gender of personae in a text, such as characters in a story, for example. The computer system advantageously includes a word map of common gendered key words, typically in the form of a predetermined array of gendered key word variables corresponding to various gendered words, typically including parts of speech, phrases and proper names, for various alternate genders, such as for male, female and non-binary genders, for example. Given a text with properly parameterized gender placeholders, the method and system of the present invention can generate an alternate version of the text based on user input as to preference of gender of personae in the text.

As discussed in the present application, gendered words include words, combinations of words, parts of speech, phrases and proper names, that can carry an indication or connotation of membership in or reference to a sexual classification, typically including the common binary categories of male and female, as well as a non-binary category separate and apart from the common binary categories of male and female. Typically, gendered words include pronouns, nouns, adjectives, verbs, adverbs, and proper names, and the like. For purposes of the present invention, gendered words are words included in or corresponding to a predetermined array, word map, or replacement map, of gendered key word variables corresponding to gendered words, typically including parts of speech, phrases and proper names, for a predetermined variety of alternate genders. The predetermined array or word map of gendered key word variables is provided to the computer system, and may also be used as a reference by a user. Proper names can be included in the predetermined array or word map of gendered key word variables, but proper names are typically provided by a user to the computer system in a character or persona legend, as will be further explained below.

Referring to the drawings, which are provided for purposes of illustration and by way of example, the present invention advantageously allows users to radically and dynamically alter the gender of characters in a text, such as in a story including multiple characters, for example. Users can read selected texts already modified for this format or submit their own texts. To modify a text, a user first inputs an original version of a text to a computer system, which identifies gendered words in the text for the user based on information provided to the computer system in the word map. The user can then insert a legend, or parameter legend, with a list of characters and alternate names for each character for alternate genders of the character, and manually tag, identify or annotate each gendered word with the appropriate associated character. Finally, the user enters a different gender in the legend for at least one character in the original text, so that the computer system can output a new, gender modified text.

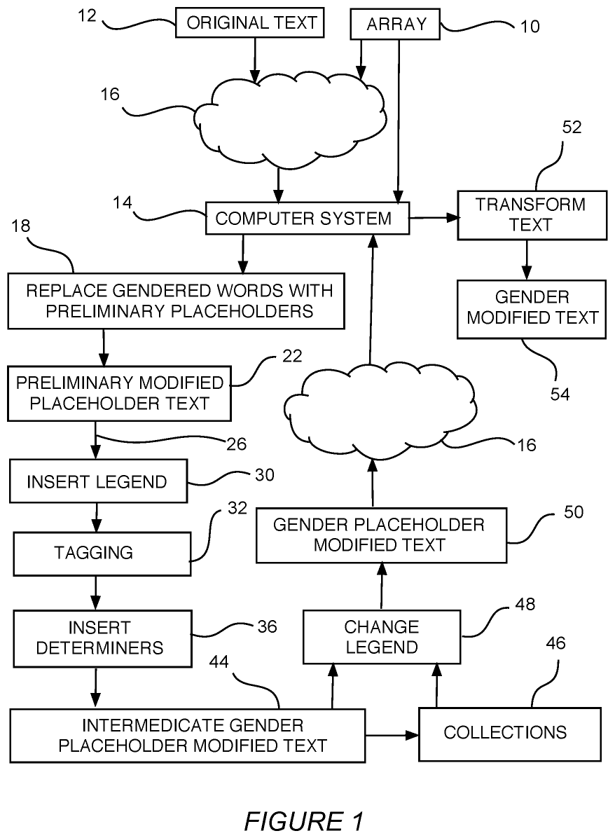

As is shown in FIG. 1, a predetermined array, or word map 10 of gendered key word variables corresponding to a plurality of words, typically including parts of speech, phrases and proper names, for a predetermined plurality of alternate genders, respectively, and an original text 12 are provided to a computer system 14, such as a server, for example, either directly or via a personal computer or other digital device, such as through the Internet 16, for example. The computer system is preferably a microprocessor based computer system having a memory for storing the original text and the predetermined array or word map of gendered key word variables, and preferably is also connected, either directly or through the Internet, so as to be accessible by users, and so as to be capable of receiving input from users and providing output to users, as will be further explained below.

In order to rewrite a text, a user can submit an original version of the text to be rewritten, without placeholders, to the computer system. The present invention also contemplates that users can rewrite selected texts approved in advance for modification, such as because the texts are out of copyright or copyright is held by the user, or because permission for modification of the texts has already been obtained from the copyright holder, for example.

In step 18, the computer system finds all of the gendered words in the original text that have corresponding key word variables in the word map, and replaces each of those gendered words in the original text with a corresponding preliminary placeholder 20, illustrated in FIG. 4, to produce a preliminary placeholder modified text 22 for review by the user. As is shown in FIG. 4, each preliminary placeholder generated by the computer system for a gendered word is typically bounded by beginning and ending double curly brackets, or other similar suitable limiters, and preferably includes the gendered word 24a, typically followed by a temporary name placeholder 24b such as “(person)” to represent the persona or character associated with the gendered word, although other similar temporary name placeholders may also be suitable.

An example of a short original text that could be provided to the computer system by a user might be:
“One midday when, after an absence of two hours, Arabella came into the room, she beheld the chair empty. Down she flopped on the bed, and sitting, meditated. ‘Now where the devil is my man gone to!’ she said.”

Except for the freestanding proper name, Arabella, and any other freestanding proper name or possessive form of such a freestanding name, as is further explained below, the computer system would find and replace each gendered word in the foregoing short text with a preliminary placeholder including the gendered word and a temporary name placeholder, illustrated in FIG. 4, and typically in the following basic format:
{{gendered word(person)}}

From the foregoing example of a short original text, the computer system would generate a preliminary placeholder modified text with temporary name placeholders, as follows:
“One midday when, after an absence of two hours, Arabella came into the room, {{she(person)}} beheld the chair empty. Down {{she(person)}} flopped on the bed, and sitting, meditated. ‘Now where the devil is my {{man(person)}} I gone to!’ {{she(person)}} said.”

To dynamically alter gender in a text, pronouns and other such gendered words must be identified, and must be associated with the appropriate corresponding character or persona in a machine-readable format, also referred to as “tagging.” As is indicated in step 26, the preliminary placeholder modified text therefore is provided to a user, to allow the user to add a legend 28 to the preliminary modified text, and for tagging of the gendered words in the preliminary placeholders of the preliminary modified text, as will be further explained below.

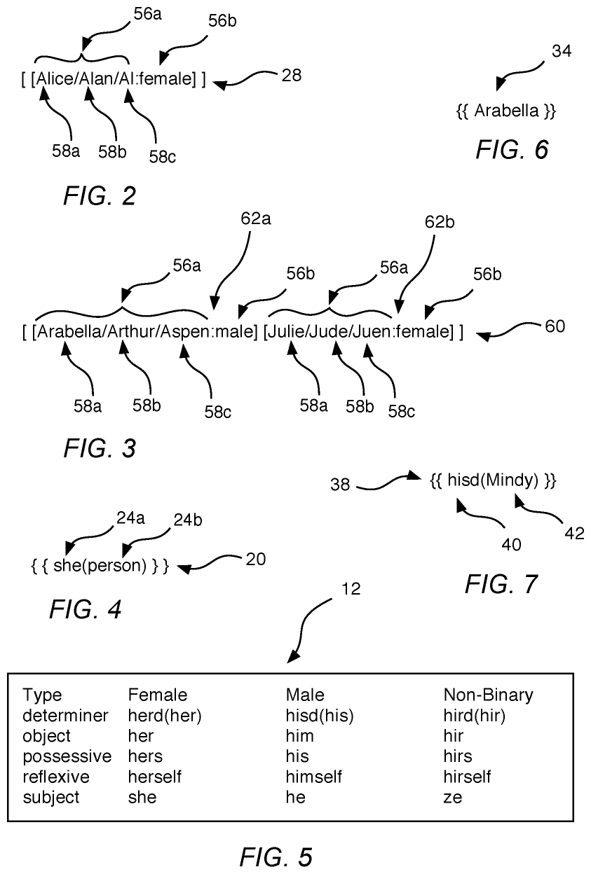

As shown in step 30, and further illustrated in FIGS. 2 and 3, at this stage, the user preferably first inserts the legend, typically at the beginning of the text, identifying choices of names for female, male, and non-binary genders for each character or persona, and preferably indicating the original or default gender for the character or persona, into the preliminary placeholder modified text, as is further explained below. Alternatively, at this stage, the user may instead indicate a different, desired gender for the character or persona to which the gender of the character or persona would be changed, into the preliminary placeholder modified text.

As is illustrated in FIG. 2 and discussed in more detail below, the legend, also called a parameter legend or character legend, typically has the following general format, for each persona or character:
[[female name/male name/non-binary name:gender]].

For multiple characters, as is illustrated in FIG. 3, the legend typically has a similar general format, as follows:
[[f. name1/m. name1/n.b. name1:gender1] [f name2/m. name2/n.b. name2:gender2]]

The legend includes a list of characters or personae with alternate names for each of the characters or personae, and a gender to be selected for each associated persona or character name. Indicating the same original or default gender for a persona or character in legend as in the original text will result in the computer system not changing the gendered words associated with the persona or character. The legend is typically added to the top of the preliminary placeholder modified text, for convenience, to assist the user in tagging the gendered words with the appropriate associated persona or character name. Alternatively, the legend can be inserted at other suitable locations in the preliminary placeholder modified text, and the legend alternatively can be inserted in the preliminary placeholder modified text after each gendered word has been tagged by the user.

As is shown in step 32, the user typically refers to the legend to then tag, or associate, each gendered word in the preliminary placeholders with an appropriate persona or character proper name for the persona or character to whom the gendered word refers, by finding and replacing each temporary name placeholder 24b, such as “(person)”, for example, in the preliminary placeholder modified text with a persona name placeholder 42, including the correct persona name, as shown in FIG. 7, so that each persona name placeholder contains the correct persona or character proper name for the gender indicated in the legend for that persona or character, to thus provide properly parameterized gender placeholders for the gendered words. For freestanding proper names, such as Arabella in the foregoing example, and any other freestanding proper name or possessive forms of such a freestanding name, the user also places these in a similar preliminary placeholder format as generated by the computer system for gendered words, as a freestanding persona name placeholder 34, typically bounded by beginning and ending double curly brackets, such as “{{Arabella}}” in keeping with the foregoing example, as shown in FIG. 6, so that the character or proper name is also indicated as an original or default name so that the computer system can identify these proper names and replace them later, if so indicated in the legend, with the correct persona or character proper name for the gender listed in the legend for that persona or character.

In the English language, possessives may be possessive pronouns (which follow a noun to which it refers, but need not be adjacent to the noun to which it refers) or possessive adjectives (which precede and modify a noun, but need not be adjacent to the noun). An idiosyncrasy of English language pronouns is that, while the male possessive adjective “his” (as in “I like his shirt”) is identical to the male possessive pronoun “his” (as in “That shirt is his”), the female possessive adjective “her” (as in “I like her shirt”) is different from the female possessive pronoun “hers” (as in “That shirt is hers”).

In order to allow the computer system to distinguish male possessive adjectives from male possessive pronouns so that the computer system can change the gender of a male possessive adjectives and pronouns accurately, in the present invention, a user finds instances of the male possessive adjective “his” and replaces them with a corresponding male determiner “hisd” in which the letter “d” has been appended to the male possessive adjective “his,” in a preliminary placeholder, including the male possessive adjective and a temporary name placeholder (such as “That is {{hisd(person)}} shirt”) in a preliminary placeholder modified text provided by the computer system for the user for differentiation from the possessive pronoun “his” (in order to avoid a possible result such as “That is hers shirt”).

Similarly, the female possessive adjective “her” (as in “I like her hairdo”) is also identical to the female pronoun used as a direct object (as in “We gave her the money”) or as an indirect object (as in “We gave it to her”), but the male possessive adjective (as in “I like his hairdo”) is different from the male pronoun used as a direct object (as in “We gave him the money”) or as an indirect object (as in “We gave it to him”). In order to allow the computer system to distinguish female possessive adjectives from female objects so that the computer system can change the gender of female possessive adjectives and objects accurately, in the present invention, a user reviews the preliminary placeholder modified text, finds instances of the female possessive adjective “her”, and replaces them with a corresponding female determiner “herd” in which the letter “d” has been appended to the female possessive adjective “her,” in a preliminary placeholder, including the female possessive adjective and a temporary name placeholder (such as “That is {{herd(person) shirt”}}) in a preliminary placeholder modified text provided by the computer system for the user, for differentiation from the female object “her” (in order to avoid a possible result such as “That is him shirt”)

Therefore, in step 36, when a gendered word in a preliminary placeholder is a possessive adjective that could otherwise be confused by the computer system with a possessive pronoun, a direct object or an indirect object, the user replaces the possessive adjective for the original gender of the persona with a key word variable denoted in the present invention as a determiner in the word map, to change each preliminary placeholder containing a possessive adjective to the appropriate determiner to form a properly parameterized gender placeholder 38, including the appropriate key word variable 40 and the correct persona name placeholder 42, as is illustrated in FIG. 7, and to generate an intermediate gender placeholder modified text 44, indicated in FIG. 1.

The present invention also contemplates that such a prepared intermediate gender placeholder modified text, typically with properly parameterized gender placeholders and the original or default gender of each character or persona indicated in the legend, can be added to a collection or library 46 of such prepared intermediate gender placeholder modified texts to allow a user to change gender of personae according to their preferences by simply selecting a different gender for any of the personae listed in the legend. In a presently preferred aspect, for purposes of utilizing a collection or library of such prepared intermediate gender placeholder modified texts, the legend may also be expanded to include other categories of information, such as a title, a genre, a date or year of publication, a word count and the author of the text to be modified, such as for a collection or library of stories prepared to allow other users to sort the stories and choose from the prepared texts according to any of these categories.

As is illustrated in step 48, a user then can then select a desired gender for one or more characters or personae in the legend, by substituting a different gender for the original or default gender of the one or more of the characters or personae, to provide a gender placeholder modified text shown at step 50 to enable the computer system to output a rewritten gender modified text, as is further explained below. Alternatively, the computer system can randomly select a gender for one or more characters or personae in the legend, to generate the gender placeholder modified text. At this stage, the gender placeholder modified text will allow the computer system to change any gender and persona names of characters as indicated by the user in the legend, and allows the computer system to properly determine the appropriate possessive adjective forms to be used.

As is shown in step 52, the computer system then transforms the gender placeholder modified text, according to the array of gendered key word variables, or word map, by replacing any gendered words in each gender placeholder with an appropriate corresponding display word, respectively, indicated in parentheses in FIG. 5, and implements any changes in personae proper names or possessives of personae proper names as indicated in the legend, to generate and output a gender modified text 54.

Referring to FIG. 2, the legend 28 preferably includes, for each character or persona, a first element 56a that preferably includes three alternate proper persona names 58a, 58b, 58c corresponding to three possible alternate genders, typically in the order female, male, and non-binary, for the persona, and a second element 56b preferably indicating one of the three alternate genders, and providing direction to the computer system as to which of the three alternate proper persona names and corresponding gender is to be used for that persona in generating the rewritten gender modified text from the gender placeholder modified text.

As is shown in FIG. 3, a multiple personae legend 60 includes a plurality of persona 62a, 62b, each having a first element 56a and a second element 56b, with each first element including three alternate proper names 58a, 58b, 58c for a persona corresponding to three alternate genders for each of the plurality of personae, respectively, and typically female, male and non-binary, in that order, and with the second element preferably indicating one of the three alternate genders. The legend may also include one or more suitable additional categories, such as a title, a genre, a date of original publication, a word count and an author of the text, to allow users to sort stories from a collection of stories according to any of these categories. In adding a legend, a user selects a desired gender from among the available alternate genders, which are typically female, male and non-binary, for each corresponding persona. Alternatively, a legend may be added by the computer system by randomly selecting one gender from among the available alternate genders for each corresponding persona.

As is illustrated in FIG. 5, showing a simplified, exemplary array or word map, in one presently preferred embodiment, for each gendered word key variable of a type or category of gendered words or phrases listed, the word map typically takes the form: type/female key/male key/non-binary key. The types of gendered words or phrases in the word map particularly typically include pronouns such as subject, object, possessive, and reflexive, as well as possessive adjectives, which are designated in the present invention as determiners. As noted above, determiners include the possessive adjective key word variables formed based upon possessive adjectives, to distinguish them from otherwise identical pronouns, and each determiner is either typically followed by the display or original possessive adjective form of the determiner in parenthesis. Alternatively, the display or original possessive adjective form of the determiner can be listed separately as the display or original forms for the determiner, as can similarly be done for other suitable gendered words or phrases having display forms different from the gendered word key variable form. Either format for the word map allows a user to readily identify the possessive adjectives that need to be changed to be determiner key word variables in the preliminary placeholder modified text, and can be used by the computer system to identify the gendered words and key word variables that need to be changed in rewriting the original text.

The word map typically also includes a broad array of other types or categories of words, such as nouns, adjectives, verbs, adverbs, and proper names, as well as phrases, and the like, which can carry a specific or implied connotation of gender, with each of these words or phrases including their own female key word variable, male key word variable and non-binary key word variable, which may also function as determiners, with corresponding original or display word forms or phrases also shown, typically either contained in parenthesis along with the key word variables or separately for each type or category, in the same fashion as the possessive adjective determiners that are listed in the word map. As an example of phrases in the word map, female, male and non-binary display forms for a category of party goers could include the phrases “party girl”, “frat boy”, and “party kid”, respectively, or other similar suitable terms. The computer system substitutes the appropriate display word or phrase for the corresponding gendered key word variable to provide the substitute gendered word or phrase corresponding to the second gender in the gender modified text. Similarly, the computer system utilizes the legend provided by the user to determine which of the three alternate proper persona names and corresponding gender is to be used for each persona in generating the rewritten gender modified text from the gender placeholder modified text.

The method and system of the invention accordingly allow a user to insert properly parameterized gender placeholders for gendered words in a text to dynamically interact with and rewrite the gender of personae or characters in texts, utilizing a computer system and an array of gendered key word variables providing the user with a word map of common gendered key words or phrases, for a set of alternate genders. The method and system of the present invention will generate an alternate version of the text based on user input as to preference of gender of personae in the text, which can be submitted by the user for preparation by insertion of properly parameterized gender placeholders for gendered words, or which can be selected from a collection of texts already prepared by insertion of properly parameterized gender placeholders for the gendered words, allowing the method and system of the invention to be used as an educational resource for learning how changing gender can affect the language used in discussing roles and relationships of men, women and non-binary people in society, and for exploring biases about gender in society, such as by readers and writers, students and teachers.

It will be apparent from the foregoing that, while particular forms of the invention have been illustrated and described, various modifications can be made without departing from the spirit and scope of the invention. Accordingly, it is not intended that the invention be limited, except as by the appended claims.

We claim:

1. A method for rewriting one or more gendered words in at least a portion of an original text, the original text including at least one persona having a corresponding first gender and at least one original gendered word corresponding to the first gender of the at least one persona, the method comprising:
providing a computer system with a predetermined array of gendered key word variables corresponding to a plurality of gendered words for a predetermined plurality of alternate genders, respectively;
providing the original text to said computer system;
said computer system finding and replacing each said at least one gendered word of said original text having a corresponding gendered key word variable in said predetermined array of gendered key word variables with a preliminary placeholder, respectively, said preliminary placeholder including the corresponding gendered key word variable and a temporary name placeholder for one of said at least one persona to which said at least one gendered word refers, to generate a preliminary placeholder modified text;
providing said preliminary placeholder modified text to a user;
the user adding a legend to said preliminary placeholder modified text, said legend including, for each said at least one persona, a plurality of different persona names, and a selected gender from among said predetermined plurality of alternate genders for said at least one persona, each of said plurality of different persona names corresponding to one of said predetermined plurality of alternate genders, respectively;
the user finding and replacing each said temporary name placeholder in each said corresponding preliminary placeholder in said preliminary placeholder modified text with a corresponding persona name placeholder including one of said persona names from said legend to which the corresponding gendered word refers, and finding and replacing each freestanding persona name in said preliminary placeholder modified text with a corresponding persona name placeholder including said freestanding persona name;
the user finding any gendered word in said preliminary placeholder modified text having a display word form and a corresponding different determiner key word variable in said predetermined array of gendered key word variables, and replacing each said display word form of said gendered word with said corresponding determiner gendered key word variable, respectively, to form corresponding gender placeholders and to generate an intermediate gender placeholder modified text;
modifying the legend in the intermediate gender placeholder modified text to change at least one selected gender for said at least one persona to a second gender different from the first gender in the original text to provide a gender placeholder modified text;
providing said gender placeholder modified text to said computer system;
said computer system transforming said gender placeholder modified text according to said array of gendered key word variables by replacing each of said gender placeholders in said personae gender indicator placeholder modified text with a corresponding one of said gendered key word variables, respectively, to generate a gender modified text; and
outputting the gender modified text.

2. The method of claim 1, wherein said predetermined plurality of alternate genders comprises three alternate genders, and said array of gendered key word variables includes a plurality of types of said at least one original gendered word, each of said plurality of types of said at least one original gendered word including three corresponding different gender key word variables indicating said three alternate genders, respectively.

3. The method of claim 2, wherein said legend includes first and second elements for each said at least one persona, wherein said first element indicates three alternate proper names corresponding to three alternate genders, respectively, and said second element indicates a preselected one of said three alternate genders.

4. The method of claim 1, wherein said array of gendered key word variables includes at least one display word form corresponding to one of said gendered key word variables and that is different from said one of said gendered key word variables, and further comprising the step of said computer system substituting said at least one display word form in said gender placeholder modified text for a corresponding one of said gendered key word variables to provide a substitute gendered word corresponding to said second gender.

5. The method of claim 4, wherein said at least one display word form comprises a possessive adjective.

6. The method of claim 1, wherein said legend includes three different names for three corresponding alternate genders and a selected one of the three alternate genders for each of a plurality of different personae, respectively.

7. The method of claim 1, wherein said legend further comprises at least one element selected from the group consisting of a title, a genre, a date of original publication, a word count and an author of the text.

8. The method of claim 1, wherein said step of modifying the legend comprises the user selecting one of said predetermined plurality of alternate genders for said at least one persona.

9. The method of claim 1, wherein said step of modifying the legend comprises said computer system randomly selecting one of said predetermined plurality of alternate genders for said at least one persona.

10. A system for rewriting one or more gendered words in at least a portion of an original text, the original text including at least one persona having a corresponding first gender and at least one original gendered word corresponding to the first gender of the at least one persona, the system comprising:
a computer system provided with a predetermined array of gendered key word variables corresponding to a plurality of gendered words for a predetermined plurality of alternate genders, respectively, said computer system being operative to find and replace each said at least one gendered word of said original text having a corresponding gendered key word variable in said predetermined array of gendered key word variables with a preliminary placeholder, respectively, said preliminary placeholder including the corresponding gendered key word variable and a temporary name placeholder for one of said at least one persona to which said at least one gendered word refers, to generate a preliminary placeholder modified text;
said computer system including means operative to permit a user to add a legend to said preliminary placeholder modified text, said legend including, for each said at least one persona, a plurality of different persona names, and a selected gender from among said predetermined plurality of alternate genders for said at least one persona, each of said plurality of different persona names corresponding to one of said predetermined plurality of alternate genders, respectively;
said computer system including means operative to permit a user to find and replace each said temporary name placeholder in each said corresponding preliminary gender indicator placeholder in said preliminary placeholder modified text with a corresponding persona name placeholder including one of said persona names from said legend to which the corresponding gendered word refers, and to find and replace each freestanding persona name in said preliminary placeholder modified text with a corresponding persona name placeholder including said freestanding persona name;
said computer system including means operative to permit a user to find any gendered word in said preliminary placeholder modified text having a display word form and a corresponding different determiner key word variable in said predetermined array of gendered key word variables, and to replace each said display word form of said gendered word with said corresponding determiner gendered key word variable, respectively, to generate an intermediate gender placeholder modified text;
said computer system including means operative to permit a user to modify the legend in the intermediate gender placeholder modified text to change at least one selected gender for the at least one persona to a second gender different from the first gender of the at least one persona in the original text, to provide a gender placeholder modified text;
said computer system being operative to transform said gender placeholder modified text according to said array of gendered key word variables by replacing each said gender placeholder in said gender placeholder modified text with a corresponding one of said gendered key word variables, respectively, to generate a gender modified text; and
means for outputting the gender modified text.

11. The system of claim 10, wherein said predetermined plurality of alternate genders comprises three alternate genders, and said array of gendered key word variables includes a plurality of types of said at least one original gendered word, each of said plurality of types of said at least one original gendered word including three corresponding different gender key word variables indicating said three alternate genders, respectively.

12. The system of claim 10, wherein said legend includes first and second elements for each said at least one persona, and wherein said first element indicates three alternate proper names corresponding to three alternate genders, respectively, and said second element indicates a preselected one of said three alternate genders.

13. The system of claim 10, wherein said array of gendered key word variables includes at least one display word form corresponding to one of said gendered key word variables and that is different from said one of said gendered key word variables, and said computer system is operative to substitute said at least one display word form in said gender placeholder modified text for a corresponding one of said gendered key word variables to provide a substitute gendered word corresponding to said second gender.

14. The system of claim 13, wherein said at least one display word form comprises a possessive adjective.

15. The system of claim 10, wherein said legend includes three different names for three corresponding alternate genders and a selected one of the three alternate genders for each of a plurality of different personae, respectively.

16. The system of claim 10, wherein said legend further comprises at least one element selected from the group consisting of a title, a genre, a date of original publication, a word count and an author of the text.
